(19) United States
(12) Patent Application Publication
(10) Pub. No.: US 2019/0181565 A1
(43) Pub. Date: Jun. 13, 2019

(54) ANTENNA SYSTEM AND MOBILE TERMINAL

(71) Applicant: AAC Technologies Pte. Ltd., Singapore City (SG)

(72) Inventors: Xiaoyue Xia, Shenzhen (CN); Chao Wang, Shenzhen (CN)

(21) Appl. No.: 16/055,858

(22) Filed: Aug. 6, 2018

(30) Foreign Application Priority Data
Dec. 13, 2017 (CN) 201711326394.X

(51) Int. Cl. H01Q 21/30; H01Q 1/24; H01Q 5/50; H01Q 5/35

(52) U.S. Cl. CPC H01Q 21/30; H01Q 5/35; H01Q 5/50; H01Q 1/241

(57) ABSTRACT

The present disclosure provides an antenna system and a mobile terminal. The antenna system includes a circuit board, a first millimeter wave array antenna electrically connected to the circuit board, and a second millimeter wave array antenna electrically connected to the circuit board. The first millimeter wave array antenna comprises a first feeding network connected to the first feeding point, and a first antenna array face fed by the first feeding network, the second millimeter wave array antenna comprises a second feeding network connected to the second feeding point, and a second antenna array face fed by the second feeding network. The first antenna array face and the second antenna array face are respectively arranged on two opposite sides of the mobile terminal.

### CROSS-REFERENCE TO RELATED APPLICATIONS

The present application claims priority to Chinese Patent Application No. 201711326394.X, filed on Dec. 13, 2017, the content of which is incorporated herein by reference in its entirety.

### TECHNICAL FIELD

The present disclosure relates to the field of electronic technologies and, in particular, to an antenna system and a mobile terminal.

### BACKGROUND

The International Telecommunication Union (ITU) defined main application scenarios of 5G at the ITU-RWPSD 22nd meeting held on June 2015. The ITU defined three main application scenarios: enhanced mobile broadband, large-scale machine communications, and highly-reliable low-latency communications. These three application scenarios respectively correspond to different key indicators. Under the enhanced mobile bandwidth scenario, the user peak speed is 20 Gbps, and the minimum user experience rate is 100 Mbps. In order to achieve these rigorous indexes, several key techniques will be utilized, including the millimeter wave technique.

Rich bandwidth resources of a millimeter wave frequency band provide guarantees for high-speed transmission rates. However, due to the severe space loss of electromagnetic waves at this frequency band, phased array architecture is needed for a wireless communication system using the millimeter wave frequency band. By means of a phase shifter, the phases of various array elements are distributed according to a certain rule, thereby forming a high-gain beam. In addition, by changing the phase shift, the beam is scanned within a certain space range. However, the scanning coverage of a single millimeter wave array antenna is generally smaller than a hemisphere (half space under a sphere coordinate system), if a terminal such as a cellphone adopts a single millimeter wave array antenna, it may cause a problem that the signal is unstable.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic structural diagram of an antenna system in accordance with a first embodiment of the present disclosure;

FIG. 2 is a schematic layout diagram of the antenna system in a mobile terminal in accordance with the first embodiment of the present disclosure;

FIG. 3 is a schematic diagram of radiation beam pointing of the antenna system in accordance with the first embodiment of the present disclosure;

FIG. 4 is a pattern of a first millimeter wave array antenna on an H plane when respective first antenna units are fed at a constant amplitude and a same phase in the antenna system in accordance with the first embodiment;

FIG. 5 is a pattern of the first millimeter wave array antenna on an E plane when respective first antenna units are fed at a constant amplitude and a same phase in the antenna system in accordance with the first embodiment;

FIG. 6 is a schematic diagram illustrating relationships between gain values and coverage efficiencies of the antenna system in accordance with a first embodiment of the present disclosure;

FIG. 7 is a schematic layout diagram of an antenna system in a mobile terminal in accordance with a second embodiment of the present disclosure; and

FIG. 8 is a schematic layout diagram of an antenna system in a mobile terminal in accordance with a third embodiment of the present disclosure.

The drawings herein are incorporated into the description and constitute a part thereof, which show embodiments of the present disclosure and are used to explain principles of the present disclosure together with the description.

### DESCRIPTION OF EMBODIMENTS

The present disclosure will be illustrated in further details with reference to the following description and the drawings.

### First Embodiment

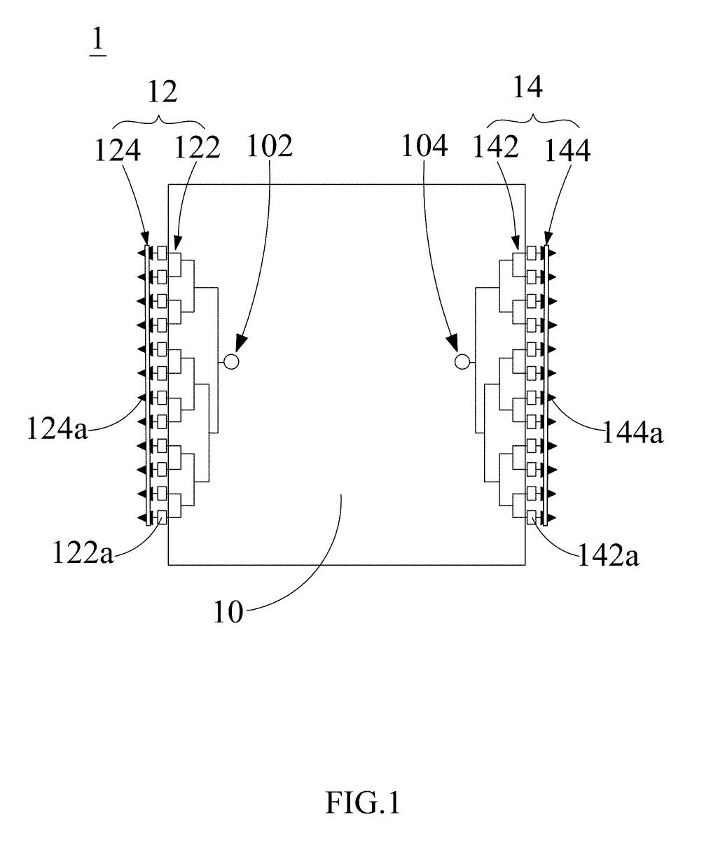

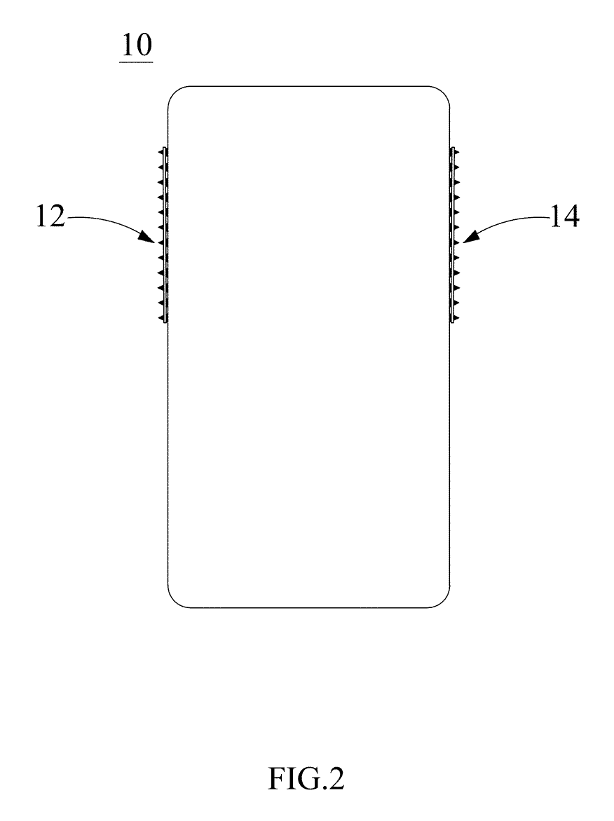

As shown in FIGS. 1-2, a first embodiment of the present disclosure provides an antenna system 1, which can be applied to a mobile terminal 10 such as a cellphone. The antenna system 1 includes a circuit board 10, a first feeding point 102 and a second feeding point 104 that are arranged on the circuit board 10, a first millimeter wave array antenna 12 electrically connected to the first feeding point 102, and a second millimeter wave array antenna 14 electrically connected to the second feeding point 104.

The first millimeter wave array antenna 12 includes a first feeding network 122 electrically connected to the first feeding point 102, and a first antenna array face 124 fed by the first feeding network 122.

The second millimeter wave array antenna 14 includes a second feeding network 142 electrically connected to the second feeding point 104, and a second antenna array face 144 fed by the second feeding network 142.

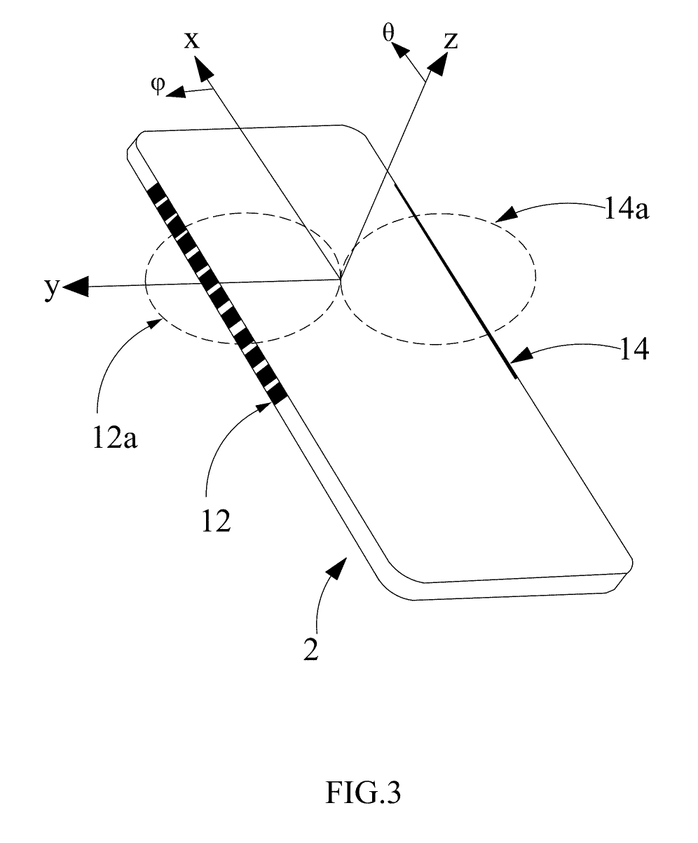

As shown in FIG. 3, the mobile terminal 10 in the present disclosure has a length direction, a width direction and a thickness direction. In the three-dimensional coordinate system, as shown in FIG. 3, the length direction of the mobile terminal 10 is a direction where the X axis of the three-dimensional coordinate system is located, the width direction of the mobile terminal 10 is a direction where the Y axis of the three-dimensional coordinate system is located, and the thickness direction of the mobile terminal 10 is a direction where the Z axis of the three-dimensional coordinate system is located. The size of the mobile terminal 10 in the length direction is greater than the size of the mobile terminal 10 in the width direction, and the size of the mobile terminal 10 in the width direction is greater than the size of the mobile terminal 10 in the thickness direction.

In the present embodiment, the first antenna array face 124 and the second antenna array face 144 are respectively arranged on opposite sides of the mobile terminal 10 along the width direction, and each of the first antenna units 124a and each of the second antenna units 144a are distributed along the length direction of the mobile terminal 10. That is to say, the first antenna array face 124 and the second antenna array face 144 are arranged on the long side of the mobile terminal 10.

The above mobile terminal 10 has a top and a bottom, and the top and the bottom are arranged opposite to each other along the length direction of the mobile terminal 10. It should be noted that, the bottom of the mobile terminal 10 is generally closer to the handhold portion of the user. In order to reduce the influence on the antenna system 1 when the user is holding the mobile terminal 10, the first and second antenna array faces 124, 144 can be arranged closer to the top than to the bottom during the design thereof.

In the present embodiment, the first antenna array face 124 includes a plurality of first antenna units 124a, and the first antenna units 124a are arranged into a one-dimensional linear array at intervals. Similarly, the second antenna array face 144 includes a plurality of second antenna units 144a, and the second antenna units 144a are arranged into a one-dimensional linear array at intervals. That is to say, both the first antenna array face 124 and the second antenna array face 144 are in the form of a one-dimensional linear array.

In the present embodiment, the above antenna array face (the first antenna array face 124 and the second antenna array face 144) can be made of a flexible circuit board, or can be made by LDS or LTCC processing, or can also be formed by a metal housing of the mobile terminal. For example, when the housing of the mobile terminal is made of metal, a portion of a side border of the housing can be made as the antenna array face. When the above antenna array face is made of a flexible circuit board, or made by LDS or LTCC technique, it can be attached onto the surface of the housing, or can be attached onto the surface of a non-metal support within the housing.

In the present embodiment, the first feeding network 122 includes a plurality of first phase shifters 122a. The number of the plurality of first phase shifters 122a is the same as the number of the first antenna units 124a. Each first antenna unit 124a is connected to the first feeding point 102 through one first phase shifter 122a. The first phase shifter 122a can control the feeding phase of the first antenna unit 124a, so as to realize beam scanning. Similarly, the second feeding network 142 includes a plurality of second phase shifters 142a. The number of the plurality of second phase shifters 142a is the same as the number of the second antenna units 144a. Each second antenna unit 144a is connected to the second feeding point 104 through one second phase shifter 142a. The second phase shifter 142a can control the feeding phase of the second antenna unit 144a, so as to achieve beam scanning.

Specifically, the radiation coverage of the first millimeter wave array antenna 12 covers a first half space, and the radiation coverage of the second millimeter wave array antenna 14 covers a second half space. The first half space and the second half space are complementary, and together form an omnidirectional space. That is to say, through arranging the first millimeter wave array antenna 12 and the second millimeter wave array antenna 14 in the mobile terminal 10, omnidirectional radiation of the antenna system 1 can be achieved.

Based on the above structure, as shown in FIG. 3, the first millimeter wave array antenna 12 and the second millimeter wave array antenna 14 form a wide beam in the θ direction. By changing the phase shift of the phase shifter, the first millimeter wave array antenna 12 and the second millimeter wave array antenna 14 scan in the φ direction. To be specific, the first millimeter wave array antenna 12 scans in the range from φ=0° to φ=180° (the first half space), and the second millimeter wave array antenna 14 scans in the range from φ=180° to φ=360° (the second half space). It should be noted that, the first radiation beam 12a and the second radiation beam 14a in FIG. 3 respectively show the radiation beam pointing of the first millimeter wave array antenna 12 and the second millimeter wave array antenna 14.

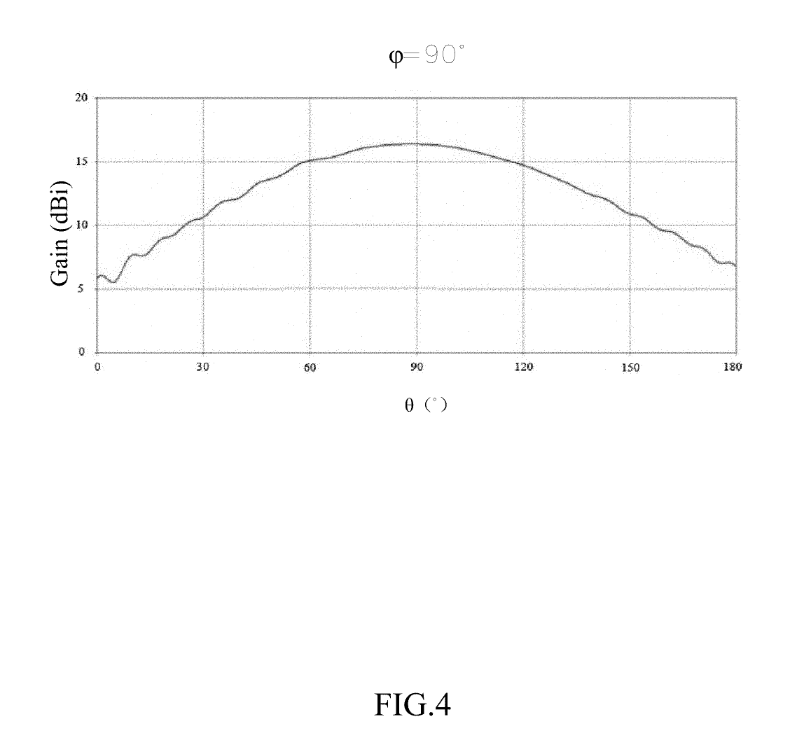

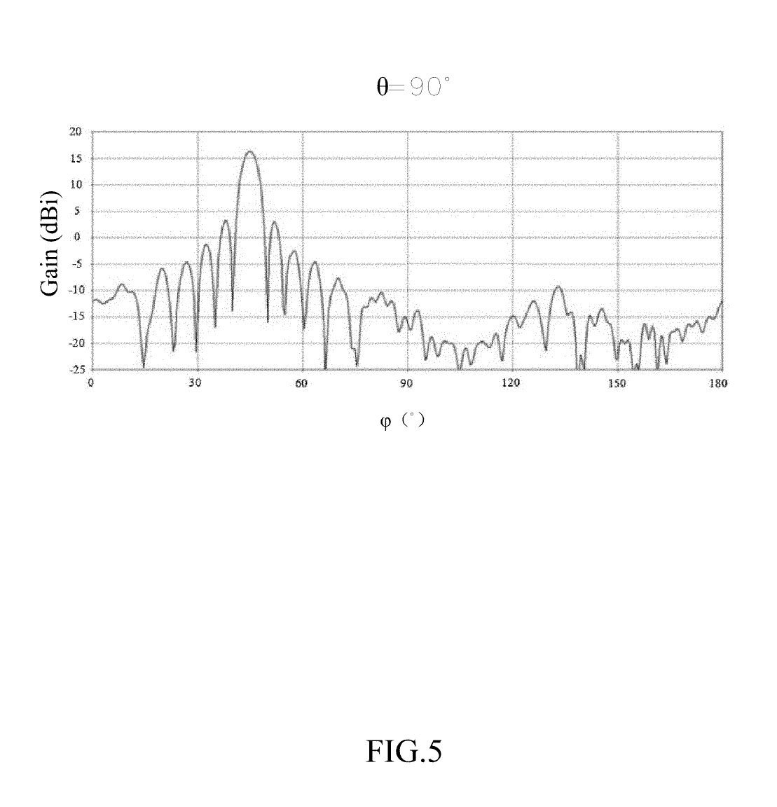

When respective first antenna units 124a are fed at a constant amplitude and a same phase, the pattern of the first millimeter wave array antenna 12 on an H plane (yoz plane in the sphere coordinate system) is shown in FIG. 4, and the pattern of the first millimeter wave array antenna 12 on an E plane (xoy plane in the sphere coordinate system) is shown in FIG. 5. When respective second antenna units 144a are fed at a constant amplitude and a same phase, the second millimeter wave array antenna 14 has a pattern similar to the first millimeter wave array antenna 12, except that its radiation beam pointing is opposite to that of the first millimeter wave array antenna 12.

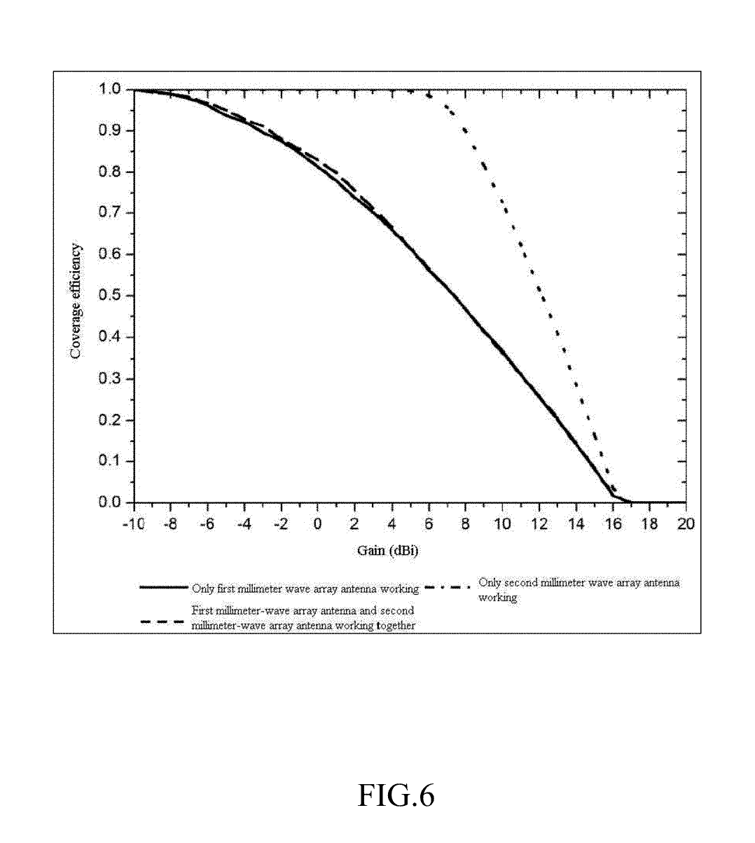

As shown in FIG. 6, when the first millimeter wave array antenna 12 and the second millimeter wave array antenna 14 are working at the same time, the coverage efficiency of the antenna system is much greater than the coverage efficiency when only one of the first and second millimeter wave array antennas 12, 14 is working. When the first and second millimeter wave array antennas 12, 14 are working at the same time and the gain is 5 dBi, the coverage efficiency is close to 1, which means the antenna system can reach a beam coverage of 5 dBi in the omnidirectional space.

In the present embodiment, the number of the first antenna units 124a is 12, and the number of the second antenna units 144a is 12. Since the number of the first phase shifters 122a is the same as the number of the first antenna units 124a and the number of the second phase shifters 142a is the same as the number of the second antenna units 144a, the number of both the first phase shifters 122a and the second phase shifters 142a is 12.

It should be noted that, the number of the first antenna units 124a and the number of the second antenna units 144a is not limited to 12, and can also be 5, 6, 15, 16, etc. The specific number can be determined according to the accommodation space within the mobile terminal and the design requirements of the antenna system 1.

In addition, both the first phase shifter 122a and the second phase shifter 142a can be 5 bit phase shifters with a phase precision of 11.25 degrees.

### Second Embodiment

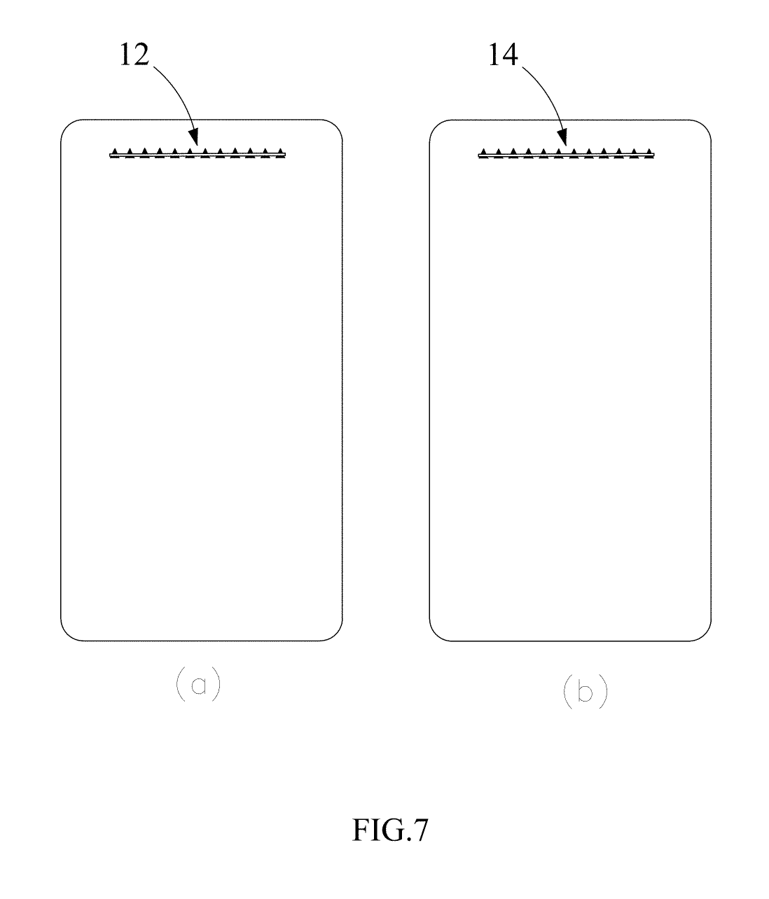

The second embodiment is generally the same as the first embodiment, except for the placement position of the antenna array face. As shown in FIG. 7, FIG. 7(a) shows a front face of a mobile terminal 20 provided by the second embodiment, and FIG. 7(b) shows a rear face of the mobile terminal 20 provided by the second embodiment. In the second embodiment, two millimeter wave array antennas are provided, that is, a first millimeter wave array antenna 12 and a second millimeter wave array antenna 14. The first antenna array face of the first millimeter wave array antenna 12 and the second antenna array face of the second millimeter wave array antenna 14 are respectively arranged on opposite sides of the mobile terminal 20 along the thickness direction, and the antenna units are arranged along the width direction of the mobile terminal 20. The first antenna array face of the first millimeter wave array antenna 12 is arranged on the front face of the mobile terminal 20, and the second antenna array face of the second millimeter wave array antenna 14 is arranged on the rear face of the mobile terminal 20. The front face of the mobile terminal 20 refers to a side where the screen is located, and the rear face refers to a side where the back shell is located. In the present embodiment, the first antenna array face and the second antenna array face are closer to the top of the mobile terminal 20, than to the bottom of the mobile terminal 20.

In the present embodiment, the working principle of the antenna system is the same as the antenna system in the first embodiment. The first millimeter wave array antenna 12 achieves beam scanning in the space outward from the screen (the first half space), and the second millimeter wave array antenna 14 achieves beam scanning in the space outward from the back shell (the second half space). Through the cooperation of the first and second millimeter wave array antennas, the coverage efficiency of the entire antenna system can be improved, and thus the signal can be more stable.

### Third Embodiment

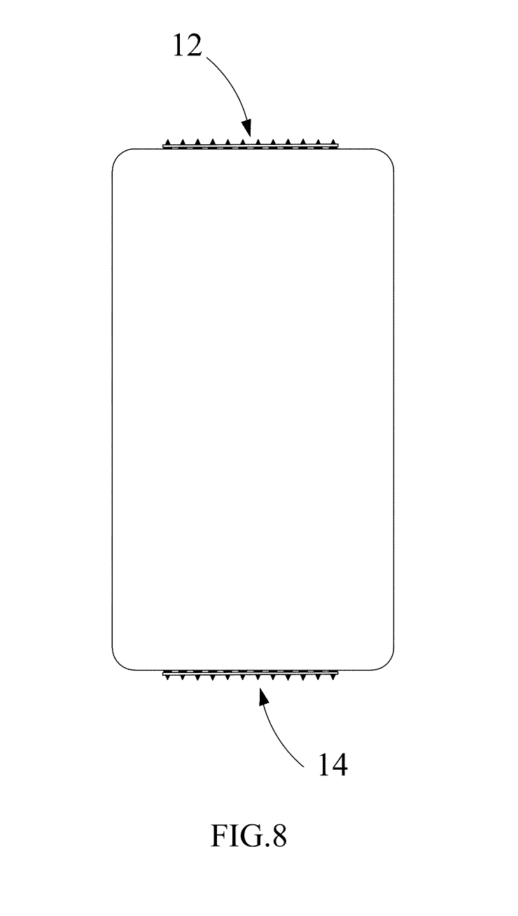

The third embodiment is generally the same as the first embodiment and the second embodiment, except for the placement position of the antenna array face. As shown in FIG. 8, in the third embodiment, a mobile terminal 30 is provided, which includes two millimeter wave array antennas are provided, that is, a first millimeter wave array antenna 12 and a second millimeter wave array antenna 14. The first antenna array face of the first millimeter wave array antenna 12 and the second antenna array face of the second millimeter wave array antenna 14 are respectively arranged on opposite sides of the mobile terminal 30 along the length direction, and the antenna units are arranged along the width direction of the mobile terminal 30. The first antenna array face of the first millimeter wave array antenna 12 is arranged at the top of the mobile terminal 30, and the second antenna array face of the second millimeter wave array antenna 14 is arranged at the bottom of the mobile terminal 30.

In the present embodiment, the working principle of the antenna system is the same as the antenna system in the first embodiment and the second embodiment. The first millimeter wave array antenna 12 achieves beam scanning in the space outward from the top of the mobile terminal 30 (the first half space), and the second millimeter wave array antenna 14 achieves beam scanning in the space outward from the bottom of the mobile terminal 30 (the second half space). Through the cooperation of the first and second millimeter wave array antennas, the coverage efficiency of the entire antenna system can be improved, and thus the signal can be more stable.

The above are preferred embodiments of the present invention, which are not intended to limit the present invention, for person skilled in the art, the present invention can have various alternations and modifications. Any modification, equivalent replacement and improvement made within the spirit and principle of the present invention shall fall into the protection scope of the present invention.

What is claimed is:

1. An antenna system applied to a mobile terminal, includes:
a circuit board,
a first feeding point arranged on the circuit board;
a second feeding point arranged on the circuit board;
a first millimeter wave array antenna electrically connected to the first feeding point; and
a second millimeter wave array antenna electrically connected to the second feeding point,
wherein the first millimeter wave array antenna comprises a first feeding network connected to the first feeding point, and a first antenna array face fed by the first feeding network,
wherein the second millimeter wave array antenna comprises a second feeding network connected to the second feeding point, and a second antenna array face fed by the second feeding network, and
wherein the first antenna array face and the second antenna array face are respectively arranged on two opposite sides of the mobile terminal.

2. The antenna system according to claim 1, wherein
the first millimeter wave array antenna achieves beam scanning in a first half space,
the second millimeter wave array antenna achieves beam scanning in a second half space, and
the first half space and the second half space together form an omnidirectional space.

3. The antenna system according to claim 2, wherein
the first antenna array face comprises a plurality of first antenna units arranged into a one-dimensional linear array at intervals, and
the second antenna array face comprises a plurality of second antenna units arranged into a one-dimensional linear array at intervals.

4. The antenna system according to claim 3, wherein
the first feeding network comprises a plurality of first phase shifters, a number of the plurality of first phase shifters is the same as a number of the plurality of first antenna units, and each of the plurality of first antenna units is electrically connected to the first feeding point through one of the plurality of first phase shifters, and
the second feeding network comprises a plurality of second phase shifters, a number of the plurality of second phase shifters is the same as a number of the plurality of second antenna units, and each of the plurality of second antenna units is electrically connected to the second feeding point through one of the plurality of second phase shifters.

5. The antenna system according to claim 4, wherein the mobile terminal has a length direction, a width direction and a thickness direction, a size of the mobile terminal in the length direction is greater than a size of the mobile terminal in the width direction, and the size of the mobile terminal in the width direction is greater than a size of the mobile terminal in the thickness direction.

6. The antenna system according to claim 5, wherein the first antenna array face and the second antenna array face are respectively arranged on two opposite sides of the mobile terminal in the width direction, and the plurality of first antenna units and the plurality of second antenna units are arranged along the length direction.

7. The antenna system according to claim 5, wherein the first antenna array face and the second antenna array face are respectively arranged on two opposite sides of the mobile terminal in the thickness direction, and the plurality of first antenna units and the plurality of second antenna units are arranged along the width direction.

8. The antenna system according to claim 5, wherein the first antenna array face and the second antenna array face are respectively arranged on two opposite sides of the mobile terminal in the length direction, and the plurality of first antenna units and the plurality of second antenna units are arranged along the width direction.

9. The antenna system according to claim 6, wherein the mobile terminal has a top and a bottom that are arranged opposite to each other along the length direction, and
wherein the first antenna array face and the second antenna array face are closer to the top, than to the bottom.

10. The antenna system according to claim 7, wherein the mobile terminal has a top and a bottom that are arranged opposite to each other along the length direction, and
wherein the first antenna array face and the second antenna array face are closer to the top, than to the bottom.

11. A mobile terminal, comprising the antenna system according to claims 1.
